(19) United States
(12) Patent Application Publication
(10) Pub. No.: US 2024/0204245 A1
(43) Pub. Date: Jun. 20, 2024

(54) LITHIUM-STUFFED GARNET THIN FILMS AND PELLETS HAVING AN OXYFLUORINATED AND/OR FLUORINATED SURFACE AND METHODS OF MAKING AND USING THE THIN FILMS AND PELLETS

(71) Applicant: QUANTUMSCAPE BATTERY, INC., San Jose, CA (US)

(72) Inventors: Cheng-Chieh CHAO, San Jose, CA (US); Lei CHENG, San Jose, CA (US); Christopher DEKMEZIAN, Campbell, CA (US); Tiffany HO, Fremont, CA (US); Timothy HOLME, Mountain View, CA (US); Tommy HUANG, San Jose, CA (US); Amal MEHROTRA, Hayward, CA (US); Aram YANG, Berkeley, CA (US)

(21) Appl. No.: 18/477,484

(22) Filed: Sep. 28, 2023

Related U.S. Application Data
(63) Continuation of application No. 17/979,083, filed on Nov. 2, 2022, now Pat. No. 11,817,551.
Application No. 17/979,083 is a continuation of application No. 16/756,386, filed on Apr. 15, 2020, now Pat. No. 11,600,850.
(60) Provisional application No. 62/582,303, filed on Nov. 6, 2017.

(51) Int. Cl. H01M 10/0562; C01G 25/00; C09C 1/40; H01M 10/0525; H01M 10/0585

(52) U.S. Cl. CPC H01M 10/0562; C01G 25/006; C09C 1/407; H01M 10/0525; H01M 10/0585; C01P 2002/30; C01P 2002/52; C01P 2002/85; C01P 2002/86; C01P 2006/40; C01P 2006/82; H01M 2300/0074

(57) ABSTRACT

Set forth herein are processes for making lithium-stuffed garnet oxides (e.g., Li₇La₃Zr₂O₁₂, also known as LLZO) that have passivated surfaces comprising a fluorinate and/or an oxyfluorinate species. These surfaces resist the formation of oxides, carbonates, hydroxides, peroxides, and organics that spontaneously form on LLZO surfaces under ambient conditions. Also set forth herein are new materials made by these processes.

### CROSS-REFERENCE TO RELATED APPLICATION

This application is a Continuation of U.S. patent application Ser. No. 16/756,386, filed Apr. 15, 2020, which is a National Stage Entry of International Patent Application No. PCT/US2018/05905, filed Nov. 6, 2018, which claims the benefit of, and priority to, U.S. Provisional Patent Application No. 62/582,303, filed Nov. 6, 2017, and titled LITHIUM-STUFFED GARNET THIN FILMS AND PELLETS HAVING AN OXYFLUORINATED AND/OR FLUORINATED SURFACE AND METHODS OF MAKING AND USING THE THIN FILMS AND PELLETS, the entire contents of each of which are herein incorporated by reference in their entirety for all purposes.

### BACKGROUND

Conventional rechargeable batteries use liquid electrolytes to physically separate and thereby electrically insulate the positive and negative electrodes (i.e., cathodes and anodes, respectively). However, liquid electrolytes suffer from several problems including flammability during thermal runaway, outgassing at high voltages, and chemical incompatibility with lithium metal negative electrodes. As an alternative, solid electrolytes have been proposed for next generation rechargeable batteries. For example, Li⁺ ion-conducting ceramic oxides, such as lithium-stuffed garnets (e.g., Li₃La₇Zr₂O₁₂, aka LLZO), have been considered as electrolyte separators. See, for example, US Patent Application Publication No. 2015/0099190, published Apr. 9, 2015, and filed Oct. 7, 2014, titled GARNET MATERIALS FOR LI SECONDARY BATTERIES AND METHODS OF MAKING AND USING GARNET MATERIALS; U.S. Pat. Nos. 8,658,317; 8,092,941; and 7,901,658; also US Patent Application Publication Nos. 2011/0281175; 2013/0085055; 2014/0093785; and 2014/0170504; also Bonderer, et al. “Free-Standing Ultrathin Ceramic Foils,” Journal of the American Ceramic Society, 2010, 93(11):3624-3631; and Murugan, et al., Angew Chem. Int. Ed. 2007, 46, 7778-7781), the entire contents of each of these publications are incorporated by reference in their entirety for all purposes.

When LLZO is sintered (e.g., US Patent Application Publication No. 2016/0087321 to Wohrle, et al.) and subsequently exposed to ambient conditions (room temperature, natural atmosphere, e.g., 78% N₂ & 21% O₂; and/or with moisture also present), the surface of LLZO is contaminated with surface species which may negatively affect Li⁺ ion-conductivity. For example, lithium carbonate (Li₂CO₃) spontaneously forms on LLZO surfaces when exposed to ambient conditions. The mechanism of lithium carbonate formation on LLZO when exposed to ambient conditions is known. For example, see Cheng, L., et al., “Interrelationships among Grain Size, Surface Composition, Air Stability, and Interfacial Resistance of Al-Substituted Li₇La₃Zr₂O₁₂ Solid Electrolytes,” ACS Appl. Mater. Interfaces, 2015, 7 (32), pp 17649-17655, which discloses that LLZO can form Li₂CO₃ via two pathways: the first pathway involves a reaction with moisture in air to form LiOH, which subsequently reacts with CO₂ to form Li₂CO₃; and the second pathway involves direct reaction between LLZO and CO₂. See also Cheng, L., et al., Phys. Chem. Chem. Phys., 2014, 16, 18294-18300, which discloses that Li₂CO₃ was formed on the surface when LLZO pellets were exposed to air. Lithium carbonate as well as other forms of surface contamination, e.g., oxides, carbonates or organics, may negatively affect the electrochemical performance of a solid electrolyte in an electrochemical device by increasing the interfacial impedance between the LLZO solid electrolyte and other electrochemical device components. Previous solutions, e.g., U.S. Pat. No. 9,966,630 B2, which issued May 8, 2018 and is titled ANNEALED GARNET ELECTROLYTE SEPARATORS, the entire contents of which are herein incorporated by reference in its entirety for all purposes, include using an annealing step to remove surface species that negatively affect electrochemical performance. However, improvements are still needed.

There is therefore a need for processes for decreasing the interfacial resistance of LLZO thin film solid electrolytes by passivating the LLZO surface, with respect to surface reactions that result in surface contaminants that negatively affect Li⁺ ion conductivity, as well as processes for removing these surface contaminants. New materials made by these processes are also needed. The instant disclosure sets forth solutions to these problems as well as other unmet needs in the relevant art.

### SUMMARY

In one embodiment, set forth herein is a process, including the following steps (1) providing a solution including a fluoride salt and a solvent; (2) providing a sintered lithium-stuffed garnet thin film or pellet; (3) immersing at least one surface of the sintered lithium-stuffed garnet thin film or pellet in the solution at a temperature between, or equal to, 0° C. and 60° C.; and (4) removing the at least one surface of the sintered lithium-stuffed garnet thin film from the solution. In some examples, the process is performed in the order in which the steps are recited.

In a second embodiment, set forth herein is a sintered lithium-stuffed garnet thin film or pellet, wherein the thin film or the pellet includes a top surface and bottom surface and a bulk therebetween, wherein the top surface or bottom surface, or both, include fluorine, and wherein the fluorine is incorporated into, or bonded to, the lithium-stuffed garnet.

In a third embodiment, set forth herein is a sintered lithium-stuffed garnet thin film made by a process set forth herein.

In a fourth embodiment, set forth herein is a method, including the following steps providing a sintered lithium-stuffed garnet thin film or pellet set forth herein; exposing the sintered thin film lithium-stuffed garnet thin film or pellet to ambient conditions; and measuring the ASR of the sintered thin film lithium-stuffed garnet; wherein the sintered lithium-stuffed garnet thin film or pellet includes: a top surface and bottom surface and a bulk therebetween, wherein the top surface or bottom surface, or both, comprise fluorine; wherein the fluorine is incorporated into, or bonded to, the lithium-stuffed garnet.

In a fifth embodiment, set forth herein is an electrochemical device including a sintered thin film lithium-stuffed garnet thin film or pellet prepared by a process set forth herein or a sintered thin film lithium-stuffed garnet thin film or pellet set forth herein.

In a sixth embodiment, set forth herein is an electric vehicle including an electrochemical device set forth herein, a sintered lithium-stuffed garnet thin film or pellet prepared by a process set forth herein, or a sintered lithium-stuffed garnet thin film or pellet set forth herein.

### BRIEF DESCRIPTIONS OF THE DRAWINGS

FIG. 1 shows X-ray photoelectron spectroscopy (XPS) results for the sintered thin films described in Example 1: (a) Non-soaked control sintered thin films, (b) sintered thin films soaked in an electrolytic solution mixture of ethylene carbonate and sulfolane (ECS) and the lithium salt, LiPF₆, (c) sintered thin films soaked in an electrolytic solution mixture of SCN and the lithium salt, LiBF₄, and (d) sintered thin films soaked in an electrolytic solution mixture of two dinitrile solvents and the lithium salt, LiBF₄ electrolytic solution.

FIG. 2 shows X-ray photoelectron spectroscopy (XPS) results for the sintered thin films described in Example 2. The plot shows the relative amount of CO₃ present, with respect to Zr present, at the surface of a lithium-stuffed garnet sintered thin film as a function of the exposure time.

FIG. 3 shows ASR of a full cell using the soaked garnet as a function of rest voltage.

FIG. 4 shows a plot of atom percentages for F, Zr, and O as a function of depth of penetration as measured by x-ray photoelectron spectroscopy (XPS).

FIG. 5 shows the chemical shifts in a Fluorine-19 solid-state nuclear magnetic resonance (NMR) spectroscopy measurement as described in Example 5.

FIG. 6 shows an illustration of an electrochemical cell made and tested in Example 3.

### DETAILED DESCRIPTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the inventions herein are not intended to be limited to the embodiments presented, but are to be accorded their widest scope consistent with the principles and novel features disclosed herein.

All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### I. General

The instant disclosure set forth processes that include simple, industrial scalable low temperature steps, which are carried out at a temperature lower than 60° C. and which enhance the interfacial property of a lithium-stuffed garnet thin film electrolyte thin film or pellet separator. As a result of the processes set forth herein, a lithium-stuffed garnet surface that is free, or has a trace fraction, of lithium carbonate is formed. The lithium-stuffed garnet surface formed (i.e., treated or modified) by the processes, herein, has a fluorinated or oxyfluorinated surface.

The invention disclosed herein uses certain types of organic electrolyte solutions to clean the surface of garnet-type solid electrolyte. A garnet thin film electrolyte is either soaked before assembly into a battery or directly used as is in the cell assembly using the organic electrolyte. As the result of the contact between the liquid electrolyte and garnet surface, surface Li₂CO₃ is etched away and garnet solid electrolyte surface is exposed. The exposed garnet surface is fluorinated or oxyfluorinated and shows improved stability in ambient environments for at least up to 3 days. The treated lithium-stuffed garnets described herein maintain a low area-specific resistance (ASR).

The processes set forth herein include, but are not limited to, (1) a process that removes the Li₂CO₃ from lithium-stuffed garnet; (2) a process that provides a fluorinated surface including Li—Zr—La—Al—O—F on lithium-stuffed garnet; and (3) a process that provides an oxyfluorinated surface including Li—Zr—La—Al—O—F on lithium-stuffed garnet.

The processes set forth herein not only remove Li₂CO₃ from lithium-stuffed garnet, but these processes also provide stable lithium-stuffed garnet surfaces that inhibit or slow the rate of formation of Li₂CO₃ when the surfaces are exposed to ambient conditions.

### II. Definitions

As used herein, the term “about,” when qualifying a number, e.g., 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, the phrase “ambient conditions,” refers to room temperature and a natural atmosphere such as the atmosphere of planet Earth that includes approximately 78% N₂ & 21% O₂; and/or with moisture also present. Ambient conditions include standard temperature and pressure, with a relative humidity of at least 1%.

As used herein, the term “annealing” refers to a process wherein a sintered electrolyte thin film is heated from 200° C. to 1000° C. in a reducing atmosphere such as but not limited to Argon, hydrogen, or a combination thereof. Example anneal processes are described in U.S. Pat. No. 9,966,630 B2, which issued May 8, 2018 and is titled ANNEALED GARNET ELECTROLYTE SEPARATORS, the entire contents of which are herein incorporated by reference in its entirety for all purposes.

As used herein, the phrase “at least one member selected from the group” includes a single member from the group, more than one member from the group, or a combination of members from the group. At least one member selected from the group consisting of A, B, and C includes, for example, A, only, B, only, or C, only, as well as A and B as well as A and C as well as B and C as well as A, B, and C or any combination of A, B, and C.

As used herein, the term “ASR” refers to area specific resistance.

As used herein, the term “bulk” refers to a portion or part of a material that is extended in space in three-dimensions by at least 1 micron (μm). The bulk refers to the portion or part of a material which is exclusive of its surface, as defined below. The bulk portion of a lithium-stuffed garnet thin film or pellet, which has a fluorinated or oxyfluorinated surface, is the interior portion of the thin film or pellet which is not fluorinated or oxyfluorinated. Whether a portion of the thin film or pellet is fluorinated or oxyfluorinated is determined by whether fluoride or oxyfluoride species are detectable by XPS in the portion. The bulk of a thin film or pellet is also characterized as the portion of the thin film or pellet which is not at the surface of the thin film or pellet and which is therefore not exposed at the surface of the thin film or pellet.

As used herein, the term “contaminant” refers to a chemical deviation from a pristine material. A contaminant in a lithium-stuffed garnet may include any material other than lithium-stuffed garnet such as, but not limited to, a lithium carbonate, a lithium hydroxide, a lithium oxide, a lithium peroxide, a hydrate thereof, an oxide thereof, or a combination thereof, wherein oxide and lithium oxide do not include a lithium-stuffed garnet. Contaminants of a garnet may include, but are not limited to, hydroxides, peroxides, oxides, carbonates, and combination thereof, which are not lithium-stuffed garnet.

As used herein, the term “drying” refers to a process of evaporating a solvent or a solution from a material such as a thin film or a pellet. Drying can be passive wherein a thin film or pellet is dried where it is stored by allowing the solvent or solution to evaporate. Drying can be active wherein a thin film or pellet is heated to drive off a solvent or a solution. Drying, storing, and heating may be performed in ambient conditions. Drying, storing, and heating may be performed in dry room conditions. Drying, storing, and heating may be performed in glove box conditions.

As used herein, the term “electrolyte” refers to an ionically conductive and electrically insulating material. Electrolytes are useful for electrically insulating the positive and negative electrodes of a rechargeable battery while allowing for the conduction of ions, e.g., Li⁺, through the electrolyte.

As used herein, the phrases “electrochemical cell” or “battery cell” shall, unless specified to the contrary, mean a single cell including a positive electrode and a negative electrode, which have ionic communication between the two using an electrolyte. In some embodiments, a battery or module includes multiple positive electrodes and/or multiple negative electrodes enclosed in one container, i.e., stacks of electrochemical cells. A symmetric cell unless specified to the contrary is a cell having two Li metal anodes separated by a solid-state electrolyte.

As used herein the phrase “electrochemical stack,” refers to one or more units which each include at least a negative electrode (e.g., Li, LiC₆), a positive electrode (e.g., Li-nickel-manganese-oxide or FeF₃, optionally combined with a solid state electrolyte or a gel electrolyte), and a solid electrolyte (e.g., lithium-stuffed garnet electrolyte set forth herein) between and in contact with the positive and negative electrodes. In some examples, between the solid electrolyte and the positive electrode, there is an additional layer comprising a gel electrolyte. An electrochemical stack may include one of these aforementioned units. An electrochemical stack may include several of these aforementioned units arranged in electrical communication (e.g., serial or parallel electrical connection). In some examples, when the electrochemical stack includes several units, the units are layered or laminated together in a column. In some examples, when the electrochemical stack includes several units, the units are layered or laminated together in an array. In some examples, when the electrochemical stack includes several units, the stacks are arranged such that one negative electrode is shared with two or more positive electrodes. Alternatively, in some examples, when the electrochemical stack includes several units, the stacks are arranged such that one positive electrode is shared with two or more negative electrodes. Unless specified otherwise, an electrochemical stack includes one positive electrode, one solid electrolyte, and one negative electrode, and optionally includes a gel electrolyte layer between the positive electrode and the solid electrolyte.

As used herein, the phrase “electrochemical device” refers to an energy storage device, such as, but not limited to a Li-secondary battery that operates or produces electricity or an electrical current by an electrochemical reaction, e.g., a conversion chemistry reaction such as 3Li⁺FeF₃↔3LiF+Fe.

As used herein, the phrase “film” or “thin film” refers to a thin membrane of less than 0.5 mm in thickness and greater than 10 nm in thickness. A thin film is also greater than 5 mm in a lateral dimension. A “film” or “thin-film” may be produced by a continuous process such as tape-casting, slip casting, or screen-printing.

As used herein, the phrase “film thickness” refers to the distance, or median measured distance, between the top and bottom faces of a film. As used herein, the top and bottom faces refer to the sides of the film having the largest surface area. As used herein, thickness is measured by cross-sectional scanning electron microscopy.

As used herein, the term “pellet” refers to a small unit of bulky material compressed into any of several shapes and sizes, e.g., cylindrical, rectangular, or spherical. The compressed material is disc-shaped and may be 5-20 cm in diameter and 0.5 to 2 cm in height. Typically, the compressed material is disc-shaped and 10 cm in diameter and 1 cm in height. Pellets may also include additional agents to help bind the material compressed into the pellet. In some examples, these additional agents are referred to as binding agents and may include, but are not limited to, polymers such as poly(ethylene)oxide. In some examples, polyvinyl butyral is used as a binding agent. Pellets are typically made by pressing a collection of powder materials in a press. This pressing makes the powder materials adhere to each other and increases the density of the collection of powder material when compared to the density of the collection of powder material before pressing. In some instances, the powder material is heated and/or an electrical current is passed through the powder material during the pressing.

As used herein, the term “pressed pellet” refers to a pellet having been submitted to a pressure (e.g., 5000 PSI) to further compress the pellet.

As used herein, the phrase “lithium-stuffed garnet” refers to oxides that are characterized by a crystal structure related to a garnet crystal structure. Lithium-stuffed garnets include compounds having the formula Li_{A}La_{B}M′_{c}M″_{D}Zr_{E}O_{F}, or Li_{A}La_{B}M′_{C}M″-_{D}Nb_{E}O_{F}, wherein 4<A<8.5, 1.5<B<4, 0<C<2, 0<D≤2; 0≤E<2.5, 10<F<13, and M′ and M″ are each, independently in each instance selected from Al, Mo, W, Nb, Ga, Sb, Ca, Ba, Sr, Ce, Hf, Rb, and Ta; or LiₐLa_{b}Zr_{c}Al_{d}Me″_{c}O_{f}, wherein 5<a<7.7; 2<b<4; 0<c≤2.5; 0≤d<2; 0≤e<2, 10<f<13 and Me″ is a metal selected from Nb, V, W, Mo, Ta, Ga, and Sb. Garnets, as used herein, also include those garnets described above that are doped with Al or Al₂O₃. Also, garnets as used herein include, but are not limited to, LiₓLa₃Zr₂O₁₂+yAl₂O₃, wherein x may be from 5.8 to 7.0, and y may be 0.1, 0.2, 0.3, 0.4, 0.5, 0.6, 0.7, 0.8, 0.9, or 1.0. As used herein, garnet does not include

YAG-garnets (i.e., yttrium aluminum garnets, or, e.g., Y₃Al₅O₁₂). As used herein, garnet does not include silicate-based garnets such as pyrope, almandine, spessartine, grossular, hessonite, or cinnamon-stone, tsavorite, uvarovite and andradite and the solid solutions pyrope-almandine-spessarite and uvarovite-grossular-andradite. Garnets herein do not include nesosilicates having the general formula X₃Y₂(SiO₄)₃ wherein X is Ca, Mg, Fe, and, or, Mn; and Y is Al, Fe, and, or, Cr.

As used herein, the phrase “lithium interfacial resistance” refers to the interfacial resistance of a material towards the incorporation or conduction of Li⁺ ions. A lithium interfacial ASR (ASR_{interface}) is calculated from the interfacial resistance (R_{interface}) via ASR_{interface}=R_{interface}*A/2 where A is the area of the electrodes in contact with the separator and the factor of 2 accounts for 2 interfaces, assuming the cell is symmetric.

As used herein, the phrase “positive electrode” refers to the electrode in a secondary battery towards which positive ions, e.g., Li⁺, conduct during discharge of the battery. As used herein, the phrase “negative electrode” refers to the electrode in a secondary battery from where positive ions, e.g., Li⁺, conduct during discharge of the battery. In a battery comprised of a Li-metal electrode and a conversion chemistry electrode (i.e., active material; e.g., NiFₓ), the electrode having the conversion chemistry materials is referred to as the positive electrode. In some common usages, cathode is used in place of positive electrode, and anode is used in place of negative electrode. When a Li-secondary battery is charged, Li ions conduct from the positive electrode (e.g., NiFₓ) towards the negative electrode (Li-metal). When a Li-secondary battery is discharged, Li ions conduct towards the positive electrode (e.g., NiFₓ; i.e., cathode) and from the negative electrode (e.g., Li-metal; i.e., anode).

As used herein, the terms “separator” refers to a solid electrolyte which conducts Li⁺ ions, is substantially insulating to electrons, and is suitable for use as a physical barrier or spacer between the positive and negative electrodes in an electrochemical cell or a rechargeable battery. A separator, as used herein, is substantially insulating to electrons when the separator's lithium ion conductivity is at least 10³ times, and typically 10⁶ times, greater than the separator's electron conductivity. Unless explicitly specified to the contrary, a separator as used herein is stable when in contact with lithium metal.

As used herein, the term “surface” refers to a material, or portion of a material, that is near or at an interface between two different phases, chemicals, or states of matter. A surface is the area of contact between two different phases or states of matter (e.g., solid-gas, liquid-gas, or solid-liquid). For example, the interface of two solids which are in direct contact with each other is a surface. For example, a thin film garnet separator when exposed to air has a surface described by the periphery or outside portion of the separator which contacts the air. For rectangular-shaped separators, there is a top and a bottom surface which both individually have higher total geometric surface areas than each of the four side surfaces individually. In this rectangular-shaped separator example, there are four side surfaces which each have geometric surface areas less than either of the top and bottom surfaces. For a disc-shaped separator, there is a top and a bottom surface which both individually have higher geometric surface areas than the circumference-side of the disc-shaped separator. Geometric surface area is calculated for a square or rectangular shaped-surface by multiplying length of the surface by the width of the surface. Geometric surface area is calculated for disc-shaped surface by multiplying π by the squared radius of the disc, i.e., πr² wherein r is the radius of the disc surface. Geometric surface area is calculated for the side of a disc by multiplying the disc circumference by the width of the side of the disc. When used as an electrolyte in an electrochemical cell, either the top or bottom surface is the surface of the separator which directly contacts the negative electrode (e.g., Li metal), the positive electrode (i.e. cathode or catholyte in the cathode), and/or a layer or adhesive bonding agent disposed between the separator and the positive electrode. A surface is defined by an area that has larger, or more extended, x- and y-axis physical dimensions than it does z-axis physical dimensions, wherein the z-axis dimension is perpendicular to the surface. The depth, roughness or thickness of a surface can be of a molecular order (0.1 to 10 nanometers) of magnitude or up to 1, 2, 3, 4, or 5 μm.

As used herein, the term “top and bottom surfaces” refer to the two surfaces that have the largest total geometric surface area for a material having more than two surfaces. For example, a rectangle has six surfaces—four side surfaces and one top and one bottom surface. In such a rectangle, there is one top and one bottom surface which are parallel to each other. In a rectangle, there are four side surfaces which are perpendicular to both the top and bottom surfaces. In a rectangle, the top and bottom surfaces individually have a larger geometric surface area than the geometric surface area of each of the four side surfaces individually.

As used herein, the phrase “fluorinated” refers to the presence of a chemical species that includes fluorine or fluoride.

As used herein, the phrase “fluorinated surface” refers to a surface to which fluoride is bonded or incorporated as determined by XPS or NMR. Unless specified explicitly otherwise, the fluorinated surface feature is determined by XPS.

As used herein, the phrase “oxyfluorinated” refers to the presence of a chemical species that includes oxygen and fluorine or oxygen and fluoride.

As used herein, the phrase “oxyfluorinated surface” refers to a surface to which oxygen and fluorine is bonded or incorporated as determined by XPS or NMR. Unless specified explicitly otherwise, the oxyfluorinated surface feature is determined by XPS.

As used herein, the phrase “substantially free of” refers to the presences of a chemical species below the XPS detectable limit. For example, a lithium-stuffed garnet that is substantially free of Li₂CO₃ on its surface has Li₂CO₃ on the surface in an amount less than 1 atomic % measured by XPS. As used herein, the phrase “trace amounts of contaminants,” refers to the presences of a chemical species below the XPS detectable limit.

As used herein, the term “LiBETI” refers to lithium bis(perfluoroethanesulfonyl)imide.

As used herein, the term “LiTFSI” refers to lithium bis(trifluoromethane)sulfonimide.

As used herein, the term “LiFSI” refers lithium bis(fluorosulfonyl)imide.

As used herein, the term “LIBOB” refers to lithium bis(oxalato)borate.

As used herein, the term “XPS” refers to X-ray photoelectron spectroscopy which is a surface-sensitive quantitative spectroscopic technique that measures the elemental composition at the parts per thousand range. XPS is useful for determining the empirical formula of an analyzed species. XPS is useful for determining the chemical state and electronic state of the elements that exist within a material.

As used herein, the term “LLZO” refers to a lithium lanthanum zirconium oxide, which when crystallized into the garnet crystal form is referred to as lithium-stuffed garnet as defined above.

As used herein, the term “GITT” refers to the Galvanostatic Intermittent Titration Technique.

As used herein, the term “EIS” refers to Electrochemical Impedance Spectroscopy.

As used herein, the term “ECS” refers to a mixture of ethylene carbonate (EC) and sulfolane. Sulfolane refers to tetrahydrothiophene 1,1-dioxide, having the cyclic sulfone structure shown below

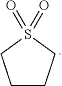

The ratio, EC:sulfolane, is 45:55 vol % unless specified to the contrary. The ratio—EC:sulfolane—may range from 3:7 to 5:5 v/v, but is understood to be 45:55 vol % unless specified otherwise.

As used herein, the term “SCN” refers to succinonitrile.

### III. Processes for Making Surface-Treated Lithium-Stuffed Garnet Electrolytes

In some examples, set forth herein is a process for making a sintered lithium-stuffed garnet thin film or pellet having a treated surface, including (1) providing a solution including a fluoride salt and a solvent; (2) providing a sintered lithium-stuffed garnet thin film or pellet; (3) immersing at least one surface of the sintered lithium-stuffed garnet thin film or pellet in the solution at a temperature between, or equal to, 0° C. and 60° C.; and (4) removing the at least one surface of the sintered lithium-stuffed garnet thin film from the solution. In some examples, the process includes (2) providing a sintered lithium-stuffed garnet thin film. In some examples, the process includes (2) providing a sintered lithium-stuffed garnet pellet. In some examples, step (2) includes providing a sintered lithium-stuffed garnet thin film or pellet which has a pristine surface including only lithium-stuffed garnet, as determined by x-ray photoelectron spectroscopy. In some examples, the process includes (2) providing a sintered lithium-stuffed garnet pellet. In some examples, step (2) includes providing a sintered lithium-stuffed garnet thin film or pellet which has an untreated surface. In some examples, step (2) includes providing a sintered lithium-stuffed garnet thin film or pellet which has an annealed surface in which there is no detectable amount of lithium carbonate, lithium hydroxide, or lithium oxide on the surface, as detected by x-ray photoelectron spectroscopy. In some examples, the step of removing the at least one surface of the sintered lithium-stuffed garnet thin film from the solution yields a sintered lithium-stuffed garnet thin film having a fluorinated or oxyfluorinated surface.

In some examples, set forth herein is a process for treating or modifying a sintered lithium-stuffed garnet thin film or pellet having a treated surface, including (1) providing a solution including a fluoride salt and a solvent; (2) providing a sintered lithium-stuffed garnet thin film or pellet; (3) immersing at least one surface of the sintered lithium-stuffed garnet thin film or pellet in the solution at a temperature between, or equal to, 0° C. and 60° C.; and (4) removing the at least one surface of the sintered lithium-stuffed garnet thin film from the solution. In some examples, the process includes (2) providing a sintered lithium-stuffed garnet thin film. In some examples, the process includes (2) providing an untreated sintered lithium-stuffed garnet pellet.

In some examples, including any of the foregoing, the process further includes drying the sintered lithium-stuffed garnet after step (3).

In some examples, including any of the foregoing, the process further includes drying the sintered lithium-stuffed garnet after step (4).

In some examples, including any of the foregoing, the fluoride salt is selected from the group consisting of LiPF₆, lithium bis(perfluoroethanesulfonyl)imide (LIBETI), bis(trifluoromethane)sulfonimide lithium salt (LiTFSI), LiBF₄, LiAsF₆, lithium bis(fluorosulfonyl)imide (LiFSI), LiAsF₆, and combinations thereof.

In some examples, including any of the foregoing, the fluoride salt is LiPF₆.

In some examples, including any of the foregoing, the fluoride salt is lithium bis(perfluoroethanesulfonyl)imide (LIBETI).

In some examples, including any of the foregoing, the fluoride salt is bis(trifluoromethane)sulfonimide lithium salt (LiTFSI).

In some examples, including any of the foregoing, the fluoride salt is LiBF₄.

In some examples, including any of the foregoing, the fluoride salt is LiAsF₆.

In some examples, including any of the foregoing, the fluoride salt is lithium bis(fluorosulfonyl)imide (LiFSI).

In some examples, including any of the foregoing, the fluoride salt is LiBF₄ or LiPF₆.

In some examples, including any of the foregoing, the fluoride salt is LiBF₄ and LiPF₆.

In some examples, including any of the foregoing, the concentration of fluoride salt in the solution is about 0.5 M to about 1.5 M. In some examples, including any of the foregoing, the concentration is about 0.5 M, about 0.55 M, about 0.6 M, about 0.65 M, about 0.7 M, about 0.75 M, about 0.8 M, about 0.85 M, about 0.9 M, about 0.95 M, about 1.0 M, about 1.05, about 1.10, about 1.15, about 1.2, about 1.25, about 1.30, about 1.35, about 1.4, about 1.45, or about 1.5 M.

In some examples, including any of the foregoing, the concentration of fluoride salt in the solution is about 0.5 M to about 1.5 M. In some examples, including any of the foregoing, the concentration is 0.5 M, 0.55 M, 0.6 M, 0.65 M, 0.7 M, 0.75 M, 0.8 M, 0.85 M, 0.9 M, 0.95 M, 1.0 M, 1.05, 1.10, 1.15, 1.2, 1.25, 1.30, 1.35, 1.4, 1.45, or 1.5 M.

In some examples, including any of the foregoing, the concentration of fluoride salt in the solution is 0.5 M to 1.5 M. In some examples, including any of the foregoing, the concentration is 0.5 M, 0.55 M, 0.6 M, 0.65 M, 0.7 M, 0.75 M, 0.8 M, 0.85 M, 0.9 M, 0.95 M, 1.0 M, 1.05, 1.10, 1.15, 1.2, 1.25, 1.30, 1.35, 1.4, 1.45, or 1.5 M.

In some examples, including any of the foregoing, the concentration is 0.5 M.

In some examples, including any of the foregoing, the concentration is 0.55 M.

In some examples, including any of the foregoing, the concentration is 0.6 M.

In some examples, including any of the foregoing, the concentration is 0.65 M.

In some examples, including any of the foregoing, the concentration is 0.7 M.

In some examples, including any of the foregoing, the concentration is 0.75 M.

In some examples, including any of the foregoing, the concentration is 0.8 M.

In some examples, including any of the foregoing, the concentration is 0.85 M.

In some examples, including any of the foregoing, the concentration is 0.9 M.

In some examples, including any of the foregoing, the concentration is 0.95 M.

In some examples, including any of the foregoing, the concentration is 1.5 M.

In some examples, including any of the foregoing, the concentration is about 0.5 M.

In some examples, including any of the foregoing, the concentration is about 0.55 M.

In some examples, including any of the foregoing, the concentration is about 0.6 M.

In some examples, including any of the foregoing, the concentration is about 0.65 M.

In some examples, including any of the foregoing, the concentration is about 0.7 M.

In some examples, including any of the foregoing, the concentration is about 0.75 M.

In some examples, including any of the foregoing, the concentration is about 0.8 M.

In some examples, including any of the foregoing, the concentration is about 0.85 M.

In some examples, including any of the foregoing, the concentration is about 0.9 M.

In some examples, including any of the foregoing, the concentration is about 0.95 M.

In some examples, including any of the foregoing, the concentration is about 1.5 M.

In some examples, including any of the foregoing, the solvent is selected from the group consisting of ethylene carbonate (EC), diethylene carbonate, dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), γ-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, and combinations thereof. In some examples, the combinations of solvents are those combinations which are miscible.

In some examples, including any of the foregoing, the solvent is ethylene carbonate (EC).

In some examples, including any of the foregoing, the solvent is diethylene carbonate.

In some examples, including any of the foregoing, the solvent is dimethyl carbonate (DMC).

In some examples, including any of the foregoing, the solvent is ethyl-methyl carbonate (EMC).

In some examples, including any of the foregoing, the solvent is propylmethyl carbonate.

In some examples, including any of the foregoing, the solvent is nitroethyl carbonate.

In some examples, including any of the foregoing, the solvent is propylene carbonate (PC).

In some examples, including any of the foregoing, the solvent is diethyl carbonate (DEC).

In some examples, including any of the foregoing, the solvent is methyl propyl carbonate (MPC).

In some examples, including any of the foregoing, the solvent is 2,5-dioxahexanedioic acid dimethyl ester.

In some examples, including any of the foregoing, the solvent is tetrahydrofuran (THF).

In some examples, including any of the foregoing, the solvent is γ-butyrolactone (GBL).

In some examples, including any of the foregoing, the solvent is fluoroethylene carbonate (FEC).

In some examples, including any of the foregoing, the solvent is fluoromethyl ethylene carbonate (FMEC).

In some examples, including any of the foregoing, the solvent is trifluoroethyl methyl carbonate (F-EMC).

In some examples, including any of the foregoing, the solvent is fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE).

In some examples, including any of the foregoing, the solvent is fluorinated cyclic carbonate (F-AEC).

In some examples, including any of the foregoing, the solvent is dioxolane.

In some examples, including any of the foregoing, the solvent is prop-1-ene-1,3-sultone (PES).

In some examples, including any of the foregoing, the solvent is sulfolane.

In some examples, including any of the foregoing, the solvent is acetonitrile (ACN).

In some examples, including any of the foregoing, the solvent is succinonitrile (SCN).

In some examples, including any of the foregoing, the solvent is pimelonitrile.

In some examples, including any of the foregoing, the solvent is suberonitrile.

In some examples, including any of the foregoing, the solvent is propionitrile.

In some examples, including any of the foregoing, the solvent is propanedinitrile.

In some examples, including any of the foregoing, the solvent is glutaronitrile (GLN).

In some examples, including any of the foregoing, the solvent is adiponitrile (ADN).

In some examples, including any of the foregoing, the solvent is hexanedinitrile.

In some examples, including any of the foregoing, the solvent is pentanedinitrile.

In some examples, including any of the foregoing, the solvent is acetophenone.

In some examples, including any of the foregoing, the solvent is isophorone.

In some examples, including any of the foregoing, the solvent is benzonitrile.

In some examples, including any of the foregoing, the solvent is ethyl propionate.

In some examples, including any of the foregoing, the solvent is methyl propionate.

In some examples, including any of the foregoing, the solvent is methylene methanedisulfonate.

In some examples, including any of the foregoing, the solvent is dimethyl sulfate. dimethyl sulfoxide (DMSO),

In some examples, including any of the foregoing, the solvent is ethyl acetate.

In some examples, including any of the foregoing, the solvent is methyl butyrate.

In some examples, including any of the foregoing, the solvent is dimethyl ether (DME).

In some examples, including any of the foregoing, the solvent is diethyl ether.

In some examples, including any of the foregoing, the solvent is dioxolane.

In some examples, including any of the foregoing, the solvent is gamma butyl-lactone.

In some examples, including any of the foregoing, the solvent is methyl benzoate.

In some examples, including any of the foregoing, the solvent is 2-methyl-5-oxooxolane-2-carbonitrile.

In some examples, including any of the foregoing, the solvent is selected from the group consisting of succinonitrile (SCN), glutaronitile (GLN), sulfolane, ethylene carbonate (EC), ethyl-methyl carbonate (EMC), and combinations thereof.

In some examples, including any of the foregoing, the solution is any solution or electrolyte disclosed in US Patent Application Publication No. US20170331092A1, which published Nov. 16, 2017, titled as SOLID ELECTROLYTE SEPARATOR BONDING AGENT, the entire content of the application is incorporated by reference in its entirety for all purposes.

In some examples, including any of the foregoing, the solvent is a combination of SCN and GLN. In some examples, including any of the foregoing, the GLN is about 57 wt % of the solvent combination. In some embodiments, GLN is about 55 wt % to 60 wt % of the solvent combination.

In some examples, including any of the foregoing, the solvent has a water content less than 200 ppm, or less than 150 ppm, or less than 100 ppm, or less than 60 ppm, or less than 50 ppm, or less than 40 ppm, or less than 30 ppm, or less than 20 ppm, or less than 10 ppm. The water content of the solvent or the full electrolyte mixture moisture is measured by Karl Fischer coulometric titration, using a Mettler Toledo C20. The catholyte “Coulomat CG-K” and the anolyte “Hydranal AK” are used in the titration and the electrolyte is directly injected into the system for moisture analysis. Both catholyte and anolyte can be purchased from Fluka.

In some examples, including any of the foregoing, the electrolyte solution is selected from those disclosed in US Patent Application Publication No. US20170331092A1, which published Nov. 16, 2017, titled as SOLID ELECTROLYTE SEPARATOR BONDING AGENT, the entire content of the application is incorporated by reference in its entirety for all purposes.

In some examples, including any of the foregoing, the electrolyte solution comprises or is one of the following solvent and fluoride salt combinations: ECS and LiPF₆, SCN and LiBF₄, and SCN+GLN and LiBF₄.

In some examples, including any of the foregoing, the solvent is a combination of SCN and GLN.

In some examples, including any of the foregoing, the GLN is present at 57 wt % of the solution.

In some examples, including any of the foregoing, the solvent has a water content less than 200 ppm, or less than 150 ppm, or less than 100 ppm, or less than 60 ppm, or less than 50 ppm, or less than 40 ppm, or less than 30 ppm, or less than 20 ppm, or less than 10 ppm.

In some examples, including any of the foregoing, the temperature is selected from the group consisting of about 20° C., about 25° C., about 30° C., about 35° C., about 40° C., about 45° C., about 50° C., about 55° C., and about 60° C.

In some examples, including any of the foregoing, the temperature is about 20° C.

In some examples, including any of the foregoing, the temperature is about 25° C.

In some examples, including any of the foregoing, the temperature is about 30° C.

In some examples, including any of the foregoing, the temperature is about 35° C.

In some examples, including any of the foregoing, the temperature is about 40° C.

In some examples, including any of the foregoing, the temperature is about 45° C.

In some examples, including any of the foregoing, the temperature is about 50° C.

In some examples, including any of the foregoing, the temperature is about 55° C.

In some examples, including any of the foregoing, the temperature is about 60° C.

In some examples, including any of the foregoing, the temperature is selected from the group consisting of 20° C., 25° C., and 30° C. In some embodiments, the at least a surface of a sintered thin film garnet is soaked in the electrolyte solution at a temperature that ranges from about 20 to about 60° C. In some embodiments, the temperature ranges from 20 to 25° C., 20 to 30° C., 20 to 35° C., 20 to 40° C., 20 to 45° C., 20 to 50° C., 25 to 30° C., 25 to 35° C., 25 to 40° C., 30 to 35° C., 30 to 40° C., 35 to 40° C., 35 to 45° C., 35 to 50° C., or 40 to 50° C.

In some embodiments, the temperature is selected from the group consisting of about 20° C., about 25° C., about 30° C., about 35° C., about 40° C., about 45° C., about 50° C., and about 55° C.

In some embodiments, the temperature is selected from the group consisting of 20° C., 25° C., 30° C., 35° C., 40° C., 45° C., 50° C., and 55° C.

In some embodiments, the temperature is 35° C., 40° C., 45° C., 50° C., 55° C., or 60° C.

In some embodiments, the temperature is 60° C.

In some examples, including any of the foregoing, the temperature is 60° C.

In some examples, including any of the foregoing, the lithium-stuffed garnet thin film or pellet, prior to step 3, is characterized by the chemical formula Li_{A}La_{B}Al_{C}M″_{D}Zr_{E}O_{F}, wherein 5<A<8, 1.5<B<4, 0.1<C<2, 0≤D<2, 1<E<3, 10<F<13, and M″ is selected from the group consisting of Mo, W, Nb, Y, Ta, Ga, Sb, Ca, Ba, Sr, Ce, Hf, and Rb. In some examples, M′ and M″ are the same element selected from the from the group consisting of Al, Mo, W, Nb, Sb, Ca, Ba, Sr, Ce, Hf, Rb, and Ta. However, unless stated explicitly to the contrary, M′ and M″ are not the same element.

In some examples, including any of the foregoing, the lithium-stuffed garnet thin film or pellet, prior to step 3, is characterized by the chemical formula LiₓLa₃Zr₂O₂+yAl₂O₃, wherein x is from 5.8 to 7.0, and y is 0.1, 0.2, 0.3, 0.4, 0.5, 0.6, 0.7, 0.8, 0.9, or 1.0.

In some examples, including any of the foregoing, the lithium-stuffed garnet thin film or pellet, prior to step 3, is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, O≤C<2, O≤D<2; O<E<2, 10<F<14, and wherein M′ and M″ are each, independently, selected from the group consisting of Al, Mo, W, Nb, Sb, Ca, Ba, Sr, Ce, Hf, Rb, and Ta.

In some examples, including any of the foregoing, the lithium-stuffed garnet thin film or pellet, prior to step 3, is characterized by a formula selected from the group consisting of LiₐLa_{b}Zr_{c}Al_{d}Mₑ″ₑO_{f} wherein 5<a<7.7; 2<b<4; 0<c<2.5; 0<d<2; 0≤e<2, and 10<f<14, and wherein Me″ is a metal selected from the group consisting of Nb, Ta, V, W, Mo, and Sb.

In some examples, including any of the foregoing, the lithium-stuffed garnet thin film or pellet, prior to step 3, is characterized by a formula selected from the group consisting of LiₐLa_{b}Z_{rc}Al_{d}O_{f} wherein 5<a<7.7; 2<b<4; 0<c<2.5; 0<d<2; and 10<f<14.

In some examples, including any of the foregoing, the lithium-stuffed garnet thin film or pellet, prior to step 3, is characterized by a formula selected from the group consisting of LiₓLa₃Zr₂O₁₂·0.35Al₂O₃ wherein 4<x<8.5.

In some examples, including any of the foregoing, the lithium-stuffed garnet thin film or pellet, prior to step 3, is characterized by a formula selected from the group consisting of LiₓLa₃Zr₂O₁₂·0.5Al₂O₃ wherein 4<x<8.5.

In some examples, including any of the foregoing, the lithium-stuffed garnet thin film or pellet, prior to step 3, is characterized by a formula selected from the group consisting of LiₓLa₃Zr₂O₁₂·0.65Al₂O₃ wherein 4<x<8.5.

In some examples, including any of the foregoing, the lithium-stuffed garnet thin film or pellet, prior to step 3, is characterized by a formula selected from the group consisting of LiₓLa₃Zr₂O₁₂·Al₂O₃ wherein 4<x<8.5.

In some examples, including any of the foregoing, the at least one surface of the lithium-stuffed garnet thin film or pellet, after step 4, has a fluorinated surface.

In some examples, including any of the foregoing, the at least one surface of the lithium-stuffed garnet thin film or pellet, after step 4, has an oxyfluorinated surface.

In some examples, including any of the foregoing, the at least one surface of the lithium-stuffed garnet thin film or pellet, after step 4, has both a fluorinated and an oxyfluorinated surface.

In some examples, including any of the foregoing, the at least one surface of the lithium-stuffed garnet thin film or pellet, after step 4, has fluorine or fluoride present at a depth of penetration ranging from about 0.5 μm to about 1.5 μm.

In some examples, including any of the foregoing, the at least one surface of the lithium-stuffed garnet thin film or pellet, after step 4, has fluorine or fluoride present at a depth of penetration selected from the group consisting of about 0.5 μm, 0.6 μm, 0.7 μm, 0.8 μm, 0.9 μm, 1.0 μm, 1.1 μm, 1.2 μm, 1.3 μm, 1.4 μm, and 1.5 μm.

In some examples, including any of the foregoing, the at least one surface of the lithium-stuffed garnet thin film, after step 4, has fluorine or fluoride present at a depth of penetration of about 0.5 μm.

In some examples, including any of the foregoing, the at least one surface of the lithium-stuffed garnet thin film, after step 4, has fluorine or fluoride present at a depth of penetration of about 0.6 μm.

In some examples, including any of the foregoing, the at least one surface of the lithium-stuffed garnet thin film, after step 4, has fluorine or fluoride present at a depth of penetration of about 0.7 μm.

In some examples, including any of the foregoing, the at least one surface of the lithium-stuffed garnet thin film, after step 4, has fluorine or fluoride present at a depth of penetration of about 0.8 μm.

In some examples, including any of the foregoing, the at least one surface of the lithium-stuffed garnet thin film, after step 4, has fluorine or fluoride present at a depth of penetration of about 0.9 μm.

In some examples, including any of the foregoing, the at least one surface of the lithium-stuffed garnet thin film, after step 4, has fluorine or fluoride present at a depth of penetration of about 1.0 μm.

In some examples, including any of the foregoing, the at least one surface of the lithium-stuffed garnet thin film, after step 4, has fluorine or fluoride present at a depth of penetration of about 1.1 μm.

In some examples, including any of the foregoing, the at least one surface of the lithium-stuffed garnet thin film, after step 4, has fluorine or fluoride present at a depth of penetration of about 1.2 μm.

In some examples, including any of the foregoing, the at least one surface of the lithium-stuffed garnet thin film, after step 4, has fluorine or fluoride present at a depth of penetration of about 1.3 μm.

In some examples, including any of the foregoing, the at least one surface of the lithium-stuffed garnet thin film, after step 4, has fluorine or fluoride present at a depth of penetration of about 1.4 μm.

In some examples, including any of the foregoing, the at least one surface of the lithium-stuffed garnet thin film, after step 4, has fluorine or fluoride present at a depth of penetration of about 1.5 μm.

In some examples, including any of the foregoing, the at least one surface of the lithium-stuffed garnet pellet, after step 4, has fluorine or fluoride present at a depth of penetration of about 0.5 μm, 0.6 μm, 0.7 μm, 0.8 μm, 0.9 μm, 1.0 μm, 1.1 μm, 1.2 μm, 1.3 μm, 1.4 μm, and 1.5 μm.

In some examples, including any of the foregoing, the at least one surface of the lithium-stuffed garnet pellet, after step 4, has fluorine or fluoride present at a depth of penetration of about 0.5 μm.

In some examples, including any of the foregoing, the at least one surface of the lithium-stuffed garnet pellet, after step 4, has fluorine or fluoride present at a depth of penetration of about 0.6 μm.

In some examples, including any of the foregoing, the at least one surface of the lithium-stuffed garnet pellet, after step 4, has fluorine or fluoride present at a depth of penetration of about 0.7 μm.

In some examples, including any of the foregoing, the at least one surface of the lithium-stuffed garnet pellet, after step 4, has fluorine or fluoride present at a depth of penetration of about 0.8 μm.

In some examples, including any of the foregoing, the at least one surface of the lithium-stuffed garnet pellet, after step 4, has fluorine or fluoride present at a depth of penetration of about 0.9 μm.

In some examples, including any of the foregoing, the at least one surface of the lithium-stuffed garnet pellet, after step 4, has fluorine or fluoride present at a depth of penetration of about 1.0 μm.

In some examples, including any of the foregoing, the at least one surface of the lithium-stuffed garnet pellet, after step 4, has fluorine or fluoride present at a depth of penetration of about 1.1 μm.

In some examples, including any of the foregoing, the at least one surface of the lithium-stuffed garnet pellet, after step 4, has fluorine or fluoride present at a depth of penetration of about 1.2 μm.

In some examples, including any of the foregoing, the at least one surface of the lithium-stuffed garnet pellet, after step 4, has fluorine or fluoride present at a depth of penetration of about 1.3 μm.

In some examples, including any of the foregoing, the at least one surface of the lithium-stuffed garnet pellet, after step 4, has fluorine or fluoride present at a depth of penetration of about 1.4 μm.

In some examples, including any of the foregoing, the at least one surface of the lithium-stuffed garnet pellet, after step 4, has fluorine or fluoride present at a depth of penetration of about 1.5 μm.

Without being bound by theory, the depth of penetration can be optimized and tuned as a function of immersion time in the solution.

In some examples, including any of the foregoing, the at least one surface of the lithium-stuffed garnet thin film or pellet, after step 4, includes fluorine bonded to one or more elements in the lithium-stuffed garnet.

In some examples, including any of the foregoing, the fluorine is bonded to Al.

In some examples, including any of the foregoing, the fluorine is bonded to Zr.

In some examples, including any of the foregoing, the fluorine is bonded to La.

In some examples, including any of the foregoing, the duration of step 3 ranges from 0.1 hours to 24 hours.

In some examples, including any of the foregoing, the duration of step 3 ranges from a time selected from the group consisting of 0.5 hours, 1 hours, 1.5 hours, 2 hours, 2.5 hours, 3 hours, 3.5 hours, 4 hours, 4.5 hours, 5 hours, 5.5 hours, 6 hours, 6.5 hours, 7 hours, 7.5 hours, and 8 hours.

In some examples, including any of the foregoing, the at least one surface includes a contaminant prior to step 3.

In some examples, including any of the foregoing, the contaminant is selected from the group consisting of hydroxides, peroxides, oxides, carbonates, and combination thereof.

In some examples, including any of the foregoing, the process includes annealing the at least one surface to remove the contaminant prior to step (3).

In some examples, including any of the foregoing, the process includes annealing methods such as, but not limited to, those annealing methods described in US 2017/0214084, entitled ANNEALED GARNET ELECTROLYTE SEPARATORS, and WO/2017/131676, the entire contents of each of these publications are incorporated by reference in their entirety for all purposes.

In some examples, including any of the foregoing, the process includes annealing the at least one surface to reduce the amount of the contaminant prior to step (3).

In some examples, including any of the foregoing, the annealing the surface is in an inert or reducing atmosphere.

In some examples, including any of the foregoing, the at least one surface is free or substantially free of a contaminant after step 3.

In some examples, including any of the foregoing, the contaminant is Li₂CO₃.

In some examples, including any of the foregoing, the at least one surface has a lower interfacial resistance after step 4 than before step 3.

In some examples, including any of the foregoing, the at least one surface has a lower ASR after step 4 than before step 3.

In some examples, including any of the foregoing, the at least one surface has an ASR less than 30 Ω cm² at 45° C. after step 4. In some embodiments, the at least one surface has an area specific resistance (ASR) less than 100 Ω cm² at 45° C. In some embodiments, the ASR is less than 90, 80, 70, 60, 50, 40, 30, 20, or 10 Ω cm² at 45° C.

In some embodiments, the at least one surface has an area specific resistance (ASR) less than 30 Ω cm² at 45° C. In some embodiments, the at least one surface has an area specific resistance (ASR) less than 10 Ω cm² at 45° C. In some embodiments, the at least one surface has an area specific resistance (ASR) less than 5 Ω cm² at 45° C. In some embodiments, the at least one surface has an area specific resistance (ASR) less than 30 Ω cm² at 25° C. In some embodiments, the at least one surface has an area specific resistance (ASR) less than 10 Ω cm² at 25° C.

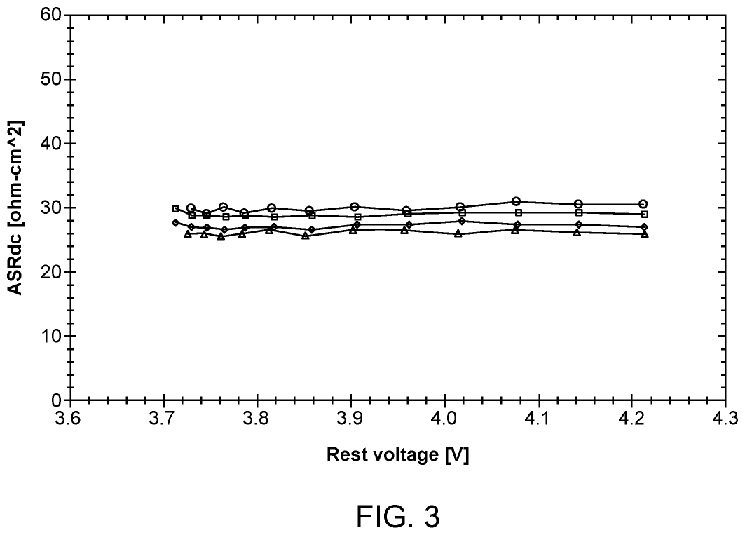

In some embodiments, the at least one surface has an area specific resistance (ASR) substantially as shown in FIG. 3.

In some embodiments, the at least one surface has an ASR stability substantially as shown in FIG. 3. In some embodiments, the at least one surface has an ASR which is more stable when exposed to ambient conditions when compared to a pristine lithium-stuffed garnet surface exposed to the same conditions. In some embodiments, the at least one surface has an ASR which is more stable when exposed to dry room conditions when compared to a pristine lithium-stuffed garnet surface exposed to the same conditions.

In some examples, including any of the foregoing, the at least one surface has a lithium ion conductivity of at least 10⁻⁴ S/cm at 45° C. after step 4.

In some examples, including any of the foregoing, the at least one surface remains free or substantially free of a contaminant in an environment of less than −40° C. dew point for up to 3 days.

In some other examples, set forth herein is a sintered lithium-stuffed garnet thin film made by any process set forth herein.

In some examples, including any of the foregoing, the methods further comprises assembling an electrochemical device which includes the sintered thin film lithium-stuffed garnet thin film or pellet.

### IV. Surface-Treated Lithium-Stuffed Garnet Electrolytes

In some examples, set forth herein is a sintered lithium-stuffed garnet thin film or pellet including a top surface and bottom surface and a bulk therebetween, wherein the top surface or bottom surface, or both, comprise fluorine; wherein the fluorine is incorporated into, or bonded to, the lithium-stuffed garnet. In some examples, the sintered lithium-stuffed garnet is a thin film. In some examples, the sintered lithium-stuffed garnet is a pellet.

In some examples, including any of the foregoing, the lithium-stuffed garnet thin film or pellet bulk is characterized by the chemical formula Li_{A}La_{B}Al_{C}M″_{D}Zr_{E}O_{F}, wherein 5<A<8, 1.5<B<4, 0.1<C<2, 0≤D<2, 1<E<3, 10<F<13, and M″ is selected from the group consisting of Mo, W, Nb, Y, Ta, Ga, Sb, Ca, Ba, Sr, Ce, Hf, and Rb.

In some examples, including any of the foregoing, the lithium-stuffed garnet thin film or pellet bulk is characterized by the chemical formula LiₓLa₃Zr₂O₁₂+yAl₂O₃, wherein x is from 5.8 to 7.0, and y is 0.1, 0.2, 0.3, 0.4, 0.5, 0.6, 0.7, 0.8, 0.9, or 1.0.

In some examples, including any of the foregoing, the lithium-stuffed garnet thin film or pellet bulk is characterized by a formula selected from the group consisting of Li_{A}La_{B}M′_{C}M″_{D}Zr_{E}O_{F}, Li_{A}La_{B}M′_{C}M″_{D}Ta_{E}O_{F}, and Li_{A}La_{B}M′_{C}M″_{D}Nb_{E}O_{F}, wherein 4<A<8.5, 1.5<B<4, O≤C<2, O<D<2; O<E<2, 10<F<14, and wherein M′ and M″ are each, independently, selected from the group consisting of Al, Mo, W, Nb, Sb, Ca, Ba, Sr, Ce, Hf, Rb, and Ta. In some examples, M′ and M″ are the same member selected from the from the group consisting of Al, Mo, W, Nb, Sb, Ca, Ba, Sr, Ce, Hf, Rb, and Ta. However, unless stated explicitly to the contrary, M′ and M″ are not the same element.

In some examples, including any of the foregoing, the lithium-stuffed garnet thin film or pellet bulk is characterized by a formula selected from the group consisting of LiₐLa_{b}Zr_{c}Al_{d}Me″ₑO_{f} wherein 5<a<7.7; 2<b<4; 0<c<2.5; 0<d<2; 0≤e<2, 10<f<14, and wherein Me″ is a metal selected from the group consisting of Nb, Ta, V, W, Mo, and Sb.

In some examples, including any of the foregoing, the lithium-stuffed garnet thin film or pellet bulk is characterized by a formula selected from the group consisting of LiₐLa_{b}Zr_{c}Al_{d}O_{f} wherein 5<a<7.7; 2<b<4; 0<c<2.5; 0<d<2; 10<f<14.

In some examples, including any of the foregoing, the lithium-stuffed garnet thin film or pellet bulk is characterized by a formula selected from the group consisting of LiₓLa₃Zr₂O₁₂·0.35Al₂O₃ wherein 4<x<8.5.

In some examples, including any of the foregoing, the lithium-stuffed garnet thin film or pellet bulk is characterized by a formula selected from the group consisting of LiₓLa₃Zr₂O₁₂·0.5Al₂O₃ wherein 4<x<8.5.

In some examples, including any of the foregoing, the lithium-stuffed garnet thin film or pellet bulk is characterized by a formula selected from the group consisting of LiₓLa₃Zr₂O₁₂·0.65Al₂O₃ wherein 4<x<8.5.

In some examples, including any of the foregoing, the lithium-stuffed garnet thin film or pellet bulk is characterized by a formula selected from the group consisting of LiₓLa₃Zr₂O₁₂·Al₂O₃ wherein 4<x<8.5.

In some examples, including any of the foregoing, the at least one surface of the lithium-stuffed garnet thin film or pellet has a fluorinated surface.

In some examples, including any of the foregoing, the at least one surface of the lithium-stuffed garnet thin film or pellet has an oxyfluorinated surface.

In some examples, including any of the foregoing, the at least one surface of the lithium-stuffed garnet thin film or pellet has both a fluorinated and an oxyfluorinated surface.

In some examples, including any of the foregoing, the at least one surface of the lithium-stuffed garnet thin film or pellet has fluorine or fluoride present at a depth of penetration ranging from about 0.5 μm to about 1.5 μm.

In some examples, including any of the foregoing, the at least one surface of the lithium-stuffed garnet thin film or pellet has fluorine or fluoride present at a depth of penetration selected from the group consisting of about 0.5 μm, 0.6 μm, 0.7 μm, 0.8 μm, 0.9 μm, 1.0 μm, 1.1 μm, 1.2 μm, 1.3 μm, 1.4 μm, and 1.5 μm.

In some examples, including any of the foregoing, the at least one surface of the lithium-stuffed garnet thin film has fluorine or fluoride present at a depth of penetration of about 0.5 μm.

In some examples, including any of the foregoing, the at least one surface of the lithium-stuffed garnet thin film, after step 4, has fluorine or fluoride present at a depth of penetration of about 0.6 μm.

In some examples, including any of the foregoing, the at least one surface of the lithium-stuffed garnet thin film has fluorine or fluoride present at a depth of penetration of about 0.7 μm.

In some examples, including any of the foregoing, the at least one surface of the lithium-stuffed garnet thin film has fluorine or fluoride present at a depth of penetration of about 0.8 μm.

In some examples, including any of the foregoing, the at least one surface of the lithium-stuffed garnet thin film has fluorine or fluoride present at a depth of penetration of about 0.9 μm.

In some examples, including any of the foregoing, the at least one surface of the lithium-stuffed garnet thin film has fluorine or fluoride present at a depth of penetration of about 1.0 μm.

In some examples, including any of the foregoing, the at least one surface of the lithium-stuffed garnet thin film has fluorine or fluoride present at a depth of penetration of about 1.1 μm.

In some examples, including any of the foregoing, the at least one surface of the lithium-stuffed garnet thin film has fluorine or fluoride present at a depth of penetration of about 1.2 μm.

In some examples, including any of the foregoing, the at least one surface of the lithium-stuffed garnet thin film has fluorine or fluoride present at a depth of penetration of about 1.3 μm.

In some examples, including any of the foregoing, the at least one surface of the lithium-stuffed garnet thin film has fluorine or fluoride present at a depth of penetration of about 1.4 μm.

In some examples, including any of the foregoing, the at least one surface of the lithium-stuffed garnet thin film has fluorine or fluoride present at a depth of penetration of about 1.5 μm.

In some examples, including any of the foregoing, the at least one surface of the lithium-stuffed garnet pellet has fluorine or fluoride present at a depth of penetration of about 0.5 μm, 0.6 μm, 0.7 μm, 0.8 μm, 0.9 μm, 1.0 μm, 1.1 μm, 1.2 μm, 1.3 μm, 1.4 μm, and 1.5 μm.

In some examples, including any of the foregoing, the at least one surface of the lithium-stuffed garnet pellet has fluorine or fluoride present at a depth of penetration of about 0.5 μm.

In some examples, including any of the foregoing, the at least one surface of the lithium-stuffed garnet pellet has fluorine or fluoride present at a depth of penetration of about 0.6 μm.

In some examples, including any of the foregoing, the at least one surface of the lithium-stuffed garnet pellet has fluorine or fluoride present at a depth of penetration of about 0.7 μm.

In some examples, including any of the foregoing, the at least one surface of the lithium-stuffed garnet pellet has fluorine or fluoride present at a depth of penetration of about 0.8 μm.

In some examples, including any of the foregoing, the at least one surface of the lithium-stuffed garnet pellet has fluorine or fluoride present at a depth of penetration of about 0.9 μm.

In some examples, including any of the foregoing, the at least one surface of the lithium-stuffed garnet pellet has fluorine or fluoride present at a depth of penetration of about 1.0 μm.

In some examples, including any of the foregoing, the at least one surface of the lithium-stuffed garnet pellet has fluorine or fluoride present at a depth of penetration of about 1.1 μm.

In some examples, including any of the foregoing, the at least one surface of the lithium-stuffed garnet pellet has fluorine or fluoride present at a depth of penetration of about 1.2 μm.

In some examples, including any of the foregoing, the at least one surface of the lithium-stuffed garnet pellet has fluorine or fluoride present at a depth of penetration of about 1.3 μm.

In some examples, including any of the foregoing, the at least one surface of the lithium-stuffed garnet pellet has fluorine or fluoride present at a depth of penetration of about 1.4 μm.

In some examples, including any of the foregoing, the at least one surface of the lithium-stuffed garnet pellet has fluorine or fluoride present at a depth of penetration of about 1.5 μm.

Without being bound by theory, the depth of penetration can be optimized and tuned as a function of immersion time in the solution.

In some examples, including any of the foregoing, the at least one surface of the lithium-stuffed garnet thin film or pellet includes fluorine bonded to one or more elements in the lithium-stuffed garnet.

In some examples, including any of the foregoing, the fluorine is bonded to Al.

In some examples, including any of the foregoing, the fluorine is bonded to Zr.

In some examples, including any of the foregoing, the fluorine is bonded to La.

In some examples, including any of the foregoing, the bulk has less than 0.5 atomic percent fluorine as measured by XPS.

In some examples, including any of the foregoing, the top or bottom surface has a thickness of about 1 nm to 10 μm. In some examples, including any of the foregoing, the top or bottom surface has a thickness of about 1 nm. In some examples, including any of the foregoing, the top or bottom surface has a thickness of about 2 nm. In some examples, including any of the foregoing, the top or bottom surface has a thickness of about 3 nm. In some examples, including any of the foregoing, the top or bottom surface has a thickness of about 4 nm. In some examples, including any of the foregoing, the top or bottom surface has a thickness of about 5 nm. In some examples, including any of the foregoing, the top or bottom surface has a thickness of about 6 nm. In some examples, including any of the foregoing, the top or bottom surface has a thickness of about 7 nm. In some examples, including any of the foregoing, the top or bottom surface has a thickness of about 8 nm. In some examples, including any of the foregoing, the top or bottom surface has a thickness of about 9 nm. In some examples, including any of the foregoing, the top or bottom surface has a thickness of about 10 nm. In some examples, including any of the foregoing, the top or bottom surface has a thickness of about 11 nm. In some examples, including any of the foregoing, the top or bottom surface has a thickness of about 12 nm. In some examples, including any of the foregoing, the top or bottom surface has a thickness of about 13 nm. In some examples, including any of the foregoing, the top or bottom surface has a thickness of about 14 nm. In some examples, including any of the foregoing, the top or bottom surface has a thickness of about 15 nm. In some examples, including any of the foregoing, the top or bottom surface has a thickness of about 20 nm. In some examples, including any of the foregoing, the top or bottom surface has a thickness of about 25 nm. In some examples, including any of the foregoing, the top or bottom surface has a thickness of about 30 nm. In some examples, including any of the foregoing, the top or bottom surface has a thickness of about 35 nm. In some examples, including any of the foregoing, the top or bottom surface has a thickness of about 40 nm. In some examples, including any of the foregoing, the top or bottom surface has a thickness of about 45 nm. In some examples, including any of the foregoing, the top or bottom surface has a thickness of about 50 nm. In some examples, including any of the foregoing, the top or bottom surface has a thickness of about 55 nm. In some examples, including any of the foregoing, the top or bottom surface has a thickness of about 60 nm. In some examples, including any of the foregoing, the top or bottom surface has a thickness of about 65 nm. In some examples, including any of the foregoing, the top or bottom surface has a thickness of about 70 nm. In some examples, including any of the foregoing, the top or bottom surface has a thickness of about 75 nm. In some examples, including any of the foregoing, the top or bottom surface In some examples, including any of the foregoing, the top or bottom surface has a thickness of about 85 nm. In some examples, including any of the foregoing, the top or bottom surface has a thickness of about 80 nm. has a thickness of about 90 nm. In some examples, including any of the foregoing, the top or bottom surface has a thickness of about 95 nm. In some examples, including any of the foregoing, the top or bottom surface has a thickness of about 100 nm. In some examples, including any of the foregoing, the top or bottom surface has a thickness of about 200 nm. In some examples, including any of the foregoing, the top or bottom surface has a thickness of about 300 nm. In some examples, including any of the foregoing, the top or bottom surface has a thickness of about 400 nm. In some examples, including any of the foregoing, the top or bottom surface has a thickness of about 500 nm. In some examples, including any of the foregoing, the top or bottom surface has a thickness of about 600 nm. In some examples, including any of the foregoing, the top or bottom surface has a thickness of about 700 nm. In some examples, including any of the foregoing, the top or bottom surface has a thickness of about 800 nm. In some examples, including any of the foregoing, the top or bottom surface has a thickness of about 900 nm. In some examples, including any of the foregoing, the top or bottom surface has a thickness of about 1000 nm. In some examples, including any of the foregoing, the top or bottom surface has a thickness of about 2 μm. In some examples, including any of the foregoing, the top or bottom surface has a thickness of about 3 μm. In some examples, including any of the foregoing, the top or bottom surface has a thickness of about 4 μm. In some examples, including any of the foregoing, the top or bottom surface has a thickness of about 5 μm. In some examples, including any of the foregoing, the top or bottom surface has a thickness of about 6 μm. In some examples, including any of the foregoing, the top or bottom surface has a thickness of about 7 μm. In some examples, including any of the foregoing, the top or bottom surface has a thickness of about 8 μm. In some examples, including any of the foregoing, the top or bottom surface has a thickness of about 9 μm. In some examples, including any of the foregoing, the top or bottom surface has a thickness of about 10 μm.

In some examples, including any of the foregoing, the top or bottom surface has a thickness of 1 nm to 10 μm. In some examples, including any of the foregoing, the top or bottom surface has a thickness of 1 nm. In some examples, including any of the foregoing, the top or bottom surface has a thickness of 2 nm. In some examples, including any of the foregoing, the top or bottom surface has a thickness of 3 nm. In some examples, including any of the foregoing, the top or bottom surface has a thickness of 4 nm. In some examples, including any of the foregoing, the top or bottom surface has a thickness of 5 nm. In some examples, including any of the foregoing, the top or bottom surface has a thickness of 6 nm. In some examples, including any of the foregoing, the top or bottom surface has a thickness of 7 nm. In some examples, including any of the foregoing, the top or bottom surface has a thickness of 8 nm. In some examples, including any of the foregoing, the top or bottom surface has a thickness of 9 nm. In some examples, including any of the foregoing, the top or bottom surface has a thickness of 10 nm. In some examples, including any of the foregoing, the top or bottom surface has a thickness of 11 nm. In some examples, including any of the foregoing, the top or bottom surface has a thickness of 12 nm. In some examples, including any of the foregoing, the top or bottom surface has a thickness of 13 nm. In some examples, including any of the foregoing, the top or bottom surface has a thickness of 14 nm. In some examples, including any of the foregoing, the top or bottom surface has a thickness of 15 nm. In some examples, including any of the foregoing, the top or bottom surface has a thickness of 20 nm. In some examples, including any of the foregoing, the top or bottom surface has a thickness of 25 nm. In some examples, including any of the foregoing, the top or bottom surface has a thickness of 30 nm. In some examples, including any of the foregoing, the top or bottom surface has a thickness of 35 nm. In some examples, including any of the foregoing, the top or bottom surface has a thickness of 40 nm. In some examples, including any of the foregoing, the top or bottom surface has a thickness of 45 nm. In some examples, including any of the foregoing, the top or bottom surface has a thickness of 50 nm. In some examples, including any of the foregoing, the top or bottom surface has a thickness of 55 nm. In some examples, including any of the foregoing, the top or bottom surface has a thickness of 60 nm. In some examples, including any of the foregoing, the top or bottom surface has a thickness of 65 nm. In some examples, including any of the foregoing, the top or bottom surface has a thickness of 70 nm. In some examples, including any of the foregoing, the top or bottom surface has a thickness of 75 nm. In some examples, including any of the foregoing, the top or bottom surface In some examples, including any of the foregoing, the top or bottom surface has a thickness of 85 nm. In some examples, including any of the foregoing, the top or bottom surface has a thickness of 80 nm. has a thickness of 90 nm. In some examples, including any of the foregoing, the top or bottom surface has a thickness of 95 nm. In some examples, including any of the foregoing, the top or bottom surface has a thickness of 100 nm. In some examples, including any of the foregoing, the top or bottom surface has a thickness of 200 nm. In some examples, including any of the foregoing, the top or bottom surface has a thickness of 300 nm. In some examples, including any of the foregoing, the top or bottom surface has a thickness of 400 nm. In some examples, including any of the foregoing, the top or bottom surface has a thickness of 500 nm. In some examples, including any of the foregoing, the top or bottom surface has a thickness of 600 nm. In some examples, including any of the foregoing, the top or bottom surface has a thickness of 700 nm. In some examples, including any of the foregoing, the top or bottom surface has a thickness of 800 nm. In some examples, including any of the foregoing, the top or bottom surface has a thickness of 900 nm. In some examples, including any of the foregoing, the top or bottom surface has a thickness of 1000 nm. In some examples, including any of the foregoing, the top or bottom surface has a thickness of 2 μm. In some examples, including any of the foregoing, the top or bottom surface has a thickness of 3 μm. In some examples, including any of the foregoing, the top or bottom surface has a thickness of 4 μm. In some examples, including any of the foregoing, the top or bottom surface has a thickness of 5 μm. In some examples, including any of the foregoing, the top or bottom surface has a thickness of 6 μm. In some examples, including any of the foregoing, the top or bottom surface has a thickness of 7 μm. In some examples, including any of the foregoing, the top or bottom surface has a thickness of 8 μm. In some examples, including any of the foregoing, the top or bottom surface has a thickness of 9 μm. In some examples, including any of the foregoing, the top or bottom surface has a thickness of 10 μm.

In some examples, including any of the foregoing, the top and bottom surface has a thickness of about 1 nm to 10 μm.

In some examples, including any of the foregoing, the sintered lithium-stuffed garnet is a thin film.

In some examples, including any of the foregoing, the sintered lithium-stuffed garnet is a pellet.

In some examples, including any of the foregoing, the top surface or bottom surface, or both, remain free or substantially free of a contaminant after exposure to ambient conditions for 1 day.

In some examples, including any of the foregoing, the top surface or bottom surface, or both, remain free or substantially free of a contaminant after exposure to ambient conditions for 1 day to 5 days.

In some examples, including any of the foregoing, the top surface or bottom surface, or both, remain free or substantially free of a contaminant after exposure to ambient conditions for 1 day to 365 days.

In some examples, including any of the foregoing, the contaminant is selected from the group consisting of hydroxides, peroxides, oxides, carbonates, and combination thereof.

In some examples, including any of the foregoing, the surface comprising fluorine is stable in ambient environment up to 3 days. In some embodiments, the surface comprising fluorine has less than 10% of surface Li₂CO₃ as measured by XPS after exposure to room temperature and a dew point of less than −10° C. for 3 days.

In some examples, including any of the foregoing, the contaminant is Li₂CO₃.

In some examples, including any of the foregoing, the top or bottom surface, or both, includes less than 10 atomic % Li₂CO₃ as measured by XPS after exposure to room temperature and a dew point of less than −10° C. for 3 days.

In some examples, including any of the foregoing, the top or bottom surface, or both, has an area specific resistance (ASR) less than 100 Ω cm² at 45° C.

In some examples, including any of the foregoing, the top or bottom surface, or both, has an area specific resistance (ASR) less than 30 Ω cm² at 45° C.

In some examples, including any of the foregoing, the top or bottom surface, or both, has an area specific resistance (ASR) less than 10 Ω cm² at 25° C.

In some examples, including any of the foregoing, the top or bottom surface, or both, has a lithium ion conductivity of at least 10⁻⁴ S/cm at 45° C.

In some examples, including any of the foregoing, the top or bottom surface, or both, includes trace amounts of contaminants.

In some examples, including any of the foregoing, set forth herein is a sintered thin film lithium-stuffed garnet comprising a top surface and bottom surface and a bulk therebetween, wherein the top surface or bottom surface, or both, comprise fluorine which is incorporated into, or bonded to, the garnet; wherein the bulk has less than 0.5 atomic percent (at %) fluorine as measured by XPS. In some examples, the bulk has 0.4 at %, 0.3 at %, 0.2 at %, or 0.1 at % fluorine as measured by XPS. In some examples, the bulk has less than 0.4 at %, 0.3 at %, 0.2 at %, or 0.1 at % fluorine as measured by XPS.

In some examples, including any of the foregoing, of the sintered thin film lithium-stuffed garnet, the top surface or bottom surface, or both, are free or substantially free of a contaminant.

In some examples, including any of the foregoing, the top surface or bottom surface, or both, remain free or substantially free of a contaminant after exposure to ambient conditions for 1 day.

In some examples, including any of the foregoing, the top surface or bottom surface, or both, remain free or substantially free of a contaminant after exposure to ambient conditions for 1 day to 5 days.

In some examples, including any of the foregoing, the top surface or bottom surface, or both, remain free or substantially free of a contaminant after exposure to ambient conditions for 1 day to 1 year.

In some examples, including any of the foregoing, the contaminant is selected from the group consisting of hydroxides, peroxides, oxides, carbonates, and combinations thereof.

In some examples, including any of the foregoing, the surface comprising fluorine has an area specific resistance (ASR) less than 100 Ωcm² at 45° C. In some examples, the surface comprising fluorine has an ASR less than 90, 80, 70, 60, 50, 40, 30, 20, or 10 Ωcm² at 45° C.

In some examples, including any of the foregoing, the surface comprising fluorine has an area specific resistance (ASR) less than 30 Ω cm² at 45° C. In some examples, the surface comprising fluorine has an area specific resistance (ASR) less than 10 Ω cm² at 45° C. In some examples, the surface comprising fluorine has an area specific resistance (ASR) less than 5 Ω cm² at 45° C. In some examples, the surface comprising fluorine has an area specific resistance (ASR) less than 30 Ω cm² at 25° C. In some examples, the surface comprising fluorine has an area specific resistance (ASR) less than 10 Ω cm² at 25° C.

In some examples, including any of the foregoing, the surface comprising fluorine has an area specific resistance (ASR) as shown in FIG. 3. In some examples, including any of the foregoing, the surface comprising fluorine has an area specific resistance (ASR) stability as shown in FIG. 3. In some examples, the surface comprising fluorine has an area specific resistance (ASR) less than 10 Ω cm² at 25° C.

In some examples, including any of the foregoing, the surface comprising fluorine has a lithium ion conductivity of at least 10⁻⁴ S/cm at 45° C.

In some examples, including any of the foregoing, the top surface or bottom surface, or both, are fluorinated and comprise trace amounts of contaminants. In some examples, the trace amount of contaminant is less than 1.0 wt %, 0.9 wt %, 0.8 wt %, 0.7 wt %, 0.6 wt %, 0.5 wt %, 0.4 wt %, 0.3 wt %, 0.2 wt %, or 0.1 wt %.

### V. Method of Using a Surface-Treated Solid-State Electrolyte

In some examples, set forth herein is a method including, providing a sintered thin film lithium-stuffed garnet film or pellet set forth herein; exposing the sintered thin film lithium-stuffed garnet thin film or pellet to ambient conditions; and measuring the ASR of the sintered thin film lithium-stuffed garnet. In some examples, the measuring occurs in a dry room. In some examples, the measuring is accomplished by electrical impedance spectroscopy (EIS).

In some examples, including any of the foregoing, the ASR does not vary by more than 10% over a surface area of at least 10 mm².

In some examples, including any of the foregoing, the ASR does not vary by more than 10% as a function of time for at least 1 day.

In some examples, including any of the foregoing, the ASR does not vary by more than 10% as a function of time for at least 365 days.

In some examples, including any of the foregoing, the ASR of the sintered thin film lithium-stuffed garnet after exposure to ambient conditions did not increase by more than 10%.

### VI. Devices and Vehicles

In some examples, set forth herein is an electrochemical device including a sintered lithium-stuffed garnet thin film set forth herein.

In some examples, set forth herein is an electric vehicle including an electrochemical device set forth herein.

In some examples, set forth herein is an electric vehicle including an electrochemical device which includes a sintered lithium-stuffed garnet thin film set forth herein.

In some examples, set forth herein is an electric vehicle which includes a sintered lithium-stuffed garnet thin film set forth herein.

### EXAMPLES

X-ray photoelectron spectroscopy (XPS) measurements were performed on a Thermo Scientific Model K-Alpha 1 XPS instrument. Monochromatic and Al X-ray source with X-ray energy of 1486.6 eV was used with a spot size of 400 μm. The base pressure when the measurement was conducted is 2*10⁻⁹ mbar or below.

Fluorine-19 (¹⁹F) solid-state NMR measurements were performed at 25° C. on a Bruker NMR Spectrometer operating at 470.5 MHz ¹⁹F NMR frequency. The MAS (Magic Angle Spinning) at high spinning speed (up to 30 kHz) was used to reduce NMR line widths. The chemical shifts were referenced with respect to trichlorofluoromethane (CFCl₃) with the fluorine peak set to 0 ppm.

### Example 1

### Electrolyte Solution Cleaning Effect on Lithium-Stuffed Garnet Thin Film Surface

This Example demonstrates a process for removing surface contaminants from the surface of LLZO thin films.

LLZO thin films were prepared as follows. Certain procedures in U.S. application Ser. No. 15/007,908 filed on Jan. 27, 2016 and published as U.S. 2017/0214048 on Jul. 27, 2017, entitled ANNEALED GARNET ELECTROLYTE SEPARATORS, the entire contents of which are herein incorporated by reference in their entirety for all purposes, were incorporated.

Lithium-Stuffed Garnet Powder was prepared. Calcined lithium-stuffed garnet powder was produced by the following series of steps. First, lithium hydroxide (LiOH), aluminum nitrate [Al(NO₃)₃9H₂O], zirconia (ZrO₂), and lanthanum oxide (La₂O₃) were massed (i.e., weighed) and mixed into a combination wherein the molar ratio of the constituent elements was Li_{7.1}Zr₂La₃O₁₂+0.5Al₂O₃. This combination was mixed and milled, using wet-milling techniques and ZrO₂ milling media, until the combination had a d₅₀ particle size of 100 nm-5 μm. Also included with the milling media was a menhaden fish oil dispersant. The milled combination of reactants was separated from the milling media after milling. The d₅₀ particle size of the milled reactants was assessed. The separated milled reactants was then placed in an alumina crucible and calcined at about nine-hundred degrees Celsius (900° C.) for approximately six (6) hours in an oven with a controlled oxidizing atmosphere in contact with the calcining reactants. The calcination process burned and/or combusted residual solvents as well as the dispersant, binder, and surfactant. The calcination caused the inorganic reactants to react to form the lithium-stuffed garnet. The calcined product was removed from the alumina crucibles after it cooled to room temperature. The product is characterized by a variety of analytical techniques, including x-ray powder diffraction (XRD) and scanning electron microscopy. This product is referred to as calcined lithium-stuffed garnet and has an empirical formula of approximately was Li_{7.1}Zr₂La₃O₁₂+0.5Al₂O₃.

The milled and calcined product were then mixed with a plasticizer (S160), a binder (B72). Alternatively, an acrylic, polyvinylbuturate (PVB), or polyvinylacetate (PVA) may be used. The solvent was a mixture of dimethyl ether/tetrahydrofuran (DME/THF). The organic components constituted 10-20 weight percent of the slurry. The remainder of the slurry was the solid calcined lithium-stuffed garnet having the empirical formula of approximately Li_{7.1}Zr₂La₃O₁₂+0.5Al₂O₃.

The slurry mixture was then tape cast using a doctor blade setting of 20 μm-400 μm to produce 10 μm-200 μm thin films of calcined but unsintered lithium-stuffed garnet in combination with surfactants, binders, plasticizers, and dispersants.

The tape cast thin films were allowed to dry. These dry calcined but unsintered thin films are referred to as green films.

The green films were placed between garnet ceramic setter plates and calcined in an oven filled with an Argon:H₂O mixture followed by an Argon:H₂ mixture and heated to 1200° C. for six (6) hours. Setter plates were used as substantially set forth in International PCT Patent Application No. PCT/US16/27886, filed Apr. 15, 2017, entitled LITHIUM STUFFED GARNET SETTER PLATES FOR SOLID ELECTROLYTE FABRICATION, the entire contents of which are herein incorporated by reference in their entirety for all purposes. The setter plates were made primarily of lithium-stuffed garnet formed into a setter. In some samples, the green films were sintered at 1125° C. for 6 hours in an oven with a controlled atmosphere in contact with the calcining reactants.

The sintered films were then exposed to air for 24-48 hours at room temperature, which resulted in the formation of Li₂CO₃ on the surface of the thin films. The sintered films with Li₂CO₃ on their surface were then placed in either a dry room or glove box for further processing with the solutions in Table 1.

The solutions in Table 1 were prepared.

TABLE 1
Combination of electrolytic solution
(solution + salt) and cleaning effect

| Solvent system | Salt (Concentration) | cleaning effect observed |
|---|---|---|
| Succinonitrile (SCN) | LiBF₄ (12 mol %) | Yes |
| SCN + GLN | LiBF₄ (12 mol %) | Yes |
| ECS | LiPF₆ (1M) | Yes |
| ECS | LiBF₄ (1M) | Yes |
| EC-EMC | LiPF₆ (1M) | Minimal |

*Glutaronitrile (GLN); ethylene carbonate and sulfolane (ECS) and ethylene carbonate-ethyl-methyl carbonate (EC-EMC).

The sintered films were individually soaked in the solutions in Table 1 at 60° C. for 12 hours. After soaking, the films were removed and dried/wiped with a Kimwipe. Then the sintered films were rinsed with isopropanol (i.e., isopropyl alcohol or IPA) and then dried in the dry room or glove box (GB).

Dry room condition were −40° C. humidity and RT (room temperature). GB conditions were argon with a O₂ partial pressure of less than 10 ppm and a H₂O partial pressure of 0.1 ppm.

A non-soaked sintered film was used as a control.

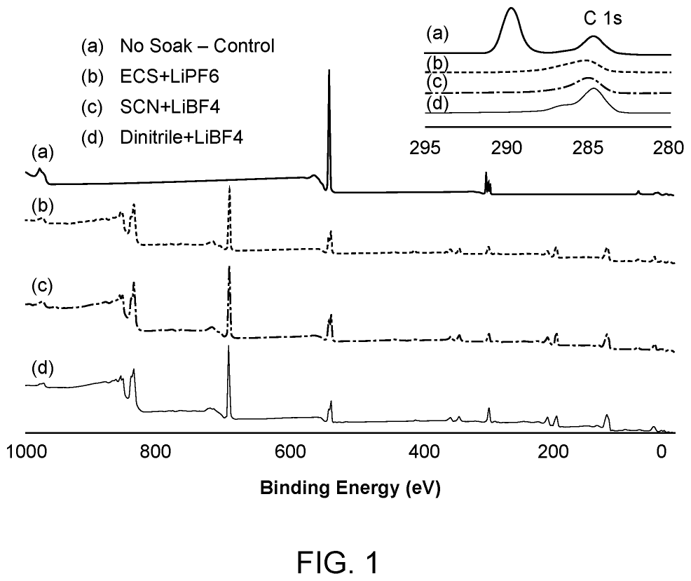

The sintered films, with and without exposure to the solutions in Table 1, were analyzed by x-ray photoelectron spectroscopy (XPS) scan between 0 and 1000 eV. The binding energy of each film was measured. The result is shown in FIG. 1.

FIG. 1 shows the binding energy data of the surfaces of the films having been treated as follows:
(a) Non-soaked control,
(b) Soaked in ECS LiPF₆ electrolyte solution,
(c) Soaked in SCN LiBF₄ electrolyte solution,
(d) Soaked in dinitrile (SCN+GLN) LiBF₄ electrolyte solution.

The data in FIG. 1 demonstrates that the Li₂CO₃ on the surface of LLZO can be removed by exposure to the solutions in Table 1.

FIG. 1 shows the results of treating sintered lithium-stuffed garnet with solutions that include either LiPF₆ or LiBF₄ fluoride salts and that include ECS, SCN solvents or combinations thereof. FIG. 1 shows, in (a), CO₃ binding energy peak at 289.8 eV which is assigned to carbon from Li₂CO₃. This peak disappears in the treated samples b-d. As carbon of the carbonate peak diminishes, lanthanum (La 4d around 102 eV), Zirconia (3d around 182 eV), and Fluorine (around 691 eV) peaks were observed.

### Example 2—Exposure Study of Clean/Soaked Films

LLZO thin films were prepared according to Example 1.

One sintered thin film was immersed in an electrolyte solution of SCN and LiBF₄ (12 mol %) at 60° C. for 12 hours. This film is referred to as the treated film.

One sintered thin film was left untreated.

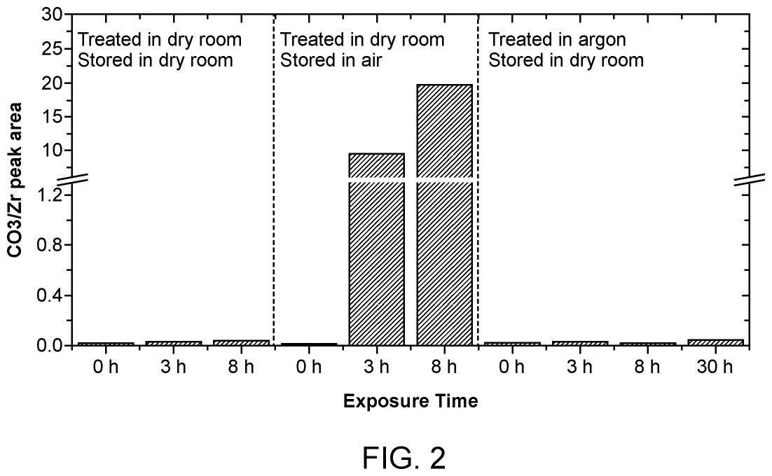

Both the treated film sample and the untreated film sample were stored in a dry room as well as in a glove box for 0, 3, and 8 hours. The C03/Zr peak area ratio for each film was measured by XPS as a function of exposure time in either the dry room or in the glove box. The result for the treated is shown in FIG. 2. The results for the treated and untreated samples are summarized in the following table:

| CO₃/Zr peak area | Time | Treatment |
|---|---|---|
| Stored in dry room for: | 0 h | ~0 |
| Stored in dry room for: | 3 h | 0.04 |
| Stored in dry room for: | 8 h | 0.08 |
| Stored in air for: | 0 h | ~0 |
| Stored in air for: | 3 h | 8 |
| Stored in air for: | 8 h | 20 |

| | | |
|---|---|---|
| | | No treatment |
| CO₃/Zr peak area | Time | (i.e., untreated) |

| | | | |
|---|---|---|---|
| Stored in dry room for: | 0 | h | ~0 |
| Stored in dry room for: | 5 | min | 12 |
| Stored in dry room for: | 1.25 | h | 18 |
| Stored in dry room for: | 24 | h | 22 |

FIG. 2 shows an exposure study of untreated and treated samples exposed in argon and dry room environments for 0, 3 and 8 hours. The result shows that the treated surface is stable for at least 30 hours in dry room environments, i.e., room temperature and −40° C. dew point, whereas the untreated surface forms lithium carbonate during the exposure time. Soaking the sintered thin film in the solution in this Example passivated the surface against forming lithium carbonate.

### Example 3—ASR Study of a Full Cell Using the Treated Samples from Examples 1 and 2

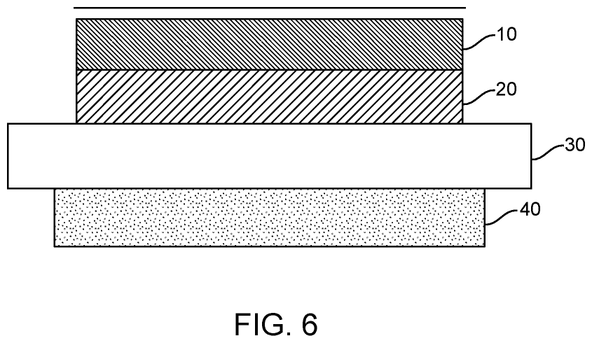

Electrochemical cells were assembled in which the treated samples from Examples 1 and 2 were used as the solid-state electrolyte separator, as illustrated in FIG. 6.

FIG. 6 shows an illustration of a full cell architecture containing a gel bonding layer (1M ECS/LiPF₆ in contact with the positive electrode and garnet separator) between the solid-state electrolyte separator (80 μm thick) and a solid-state cathode (⅔ NCA, ⅓ LSTPS catholyte, <5% dow chemical EG8200/Carbon 1.5 wt %/0.5% wt %; approximately 150 μm in thickness. In the figure, 10 is a solid-state cathode, 20 is a bonding layer (not drawn to scale), which is between the treated thin film, 30, and a lithium metal anode, 40.

The ASR of a full cell using the treated sample was tested. A Galvanostatic Intermittent Titration Technique (GITT) test was performed at 45° C. for charging between 3.7-4.3V. The charge pulses were at a C/10 rate for 30 min and the rests were 3 minutes. The test instrument was Arbin potentiostat. The ASR is plotted versus the rest voltage at the end of the rest period. Area-specific resistance was calculated by the formula, ASR_{dc}=ΔV/j, where j is the applied current density during the charge pulse and ΔV is the voltage difference between the loaded voltage and the resting voltage. The results are shown in FIG. 3.

In FIG. 3, four repeat samples (corresponding to the four plots in FIG. 3) were prepared and tested in which the sintered thin film garnet was treated with SCN+GLN and LiBF₄ (12 mol %). FIG. 3 shows the ASR testing results for full cells using these treated garnets. It was observed that they repeatedly have a low full cell ASR, of less than 30 Ω cm² at 45° C. The cathode, anode interface, and bulk separator account for 15-25 Ω cm² of the total. The separator-cathode interface has a small contribution to the total resistance.

### Example 4—Surface Concentration of Fluorine

This Example shows the depth of penetration into the surface of a sintered LLZO thin film for Fluorine (F) from the solutions in which the thin film is immersed and treated.

Fluorine atomic % was determined by XPS for the sample in Example 1 that was soaked in succinonitrile (SCN) and LiBF₄ (12 mol %) for 8 hours and at 70° C. The results are summarized below:

| | Element Atomic % | | | | |
|---|---|---|---|---|---|
| Level | Zr3d % | La4d % | O1s % | F1s % | Li1s % |
| Level 0 | 2.9 | 4 | 27.2 | 29.03 | 36.87 |
| (Surface) | | | | | |

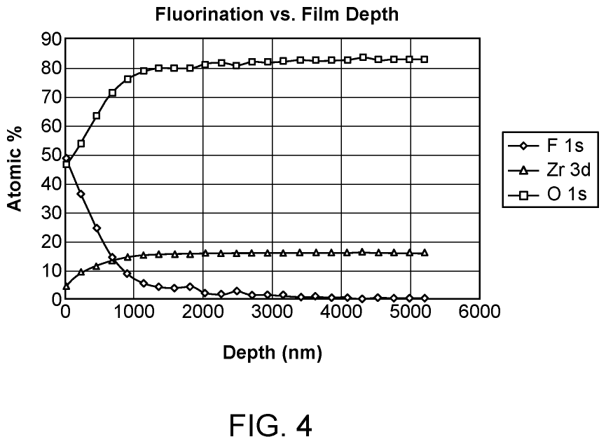

Based on the results herein, the depth of penetration into the surface of a sintered LLZO thin film for F from the solutions in which the thin film is immersed and treated was determined to be 1 μm. These results are shown in FIG. 4. FIG. 4 also shows the depth of penetration of Zr and O in the surface of the sintered LLZO thin film.

### Example 5—NMR Measurement Showing F Incorporation in the Lattice of LLZO Rather than as Another Species (e.g., LIF)

The sample from Example 4 was analyzed by ¹⁹F solid-state NMR.

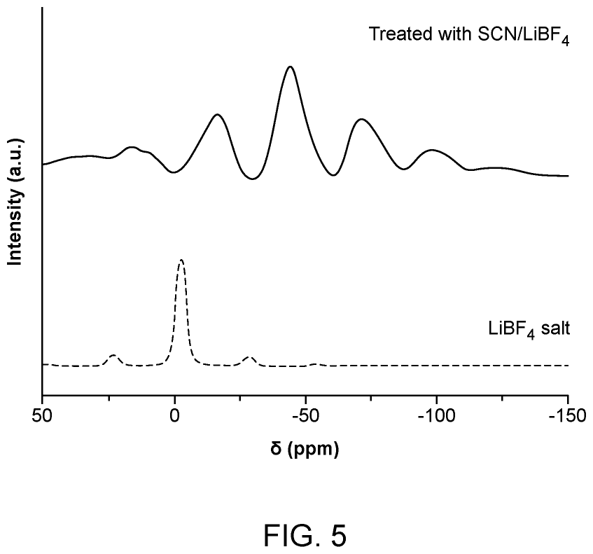

The results are shown in FIG. 5.

The NMR results show that F is incorporated into the lattice of LLZO rather than into another species, e.g. LiF.

The fluoride NMR shows shift of the peaks. The bottom spectrum is of dry LiBF₄. The spectrum is referenced at zero with CFCl₃. The top spectrum is that of the sintered LLZO thin film that was treated with SCN/LiBF₄. The fluorine peak has shifted compared to the pure LiBF₄ peak because the BF₄ has reacted with the garnet surface and changed the chemical environment.

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

1.-92. (canceled)

93. A process for making a sintered lithium-stuffed garnet thin film or pellet, comprising:
(1) providing a solution comprising a first salt and a solvent;
(2) providing a sintered lithium-stuffed garnet thin film or pellet;
(3) contacting at least one surface of the sintered lithium-stuffed garnet thin film or pellet with the solution; and
(4) removing the solution from the at least one surface of the sintered lithium-stuffed garnet thin film or pellet.

94. The process of claim 93, wherein the solution further comprises a second salt.

95. The process of claim 94, wherein the first and second salt is independently selected from the group consisting of LiPF₆, lithium bis(perfluoroethanesulfonyl)imide (LIBETI), bis(trifluoromethane)sulfonimide lithium salt (LiTFSI), LiBF₄, LiAsF₆, lithium bis(fluorosulfonyl)imide (LiFSI), and combinations thereof.

96. The process of claim 94, wherein the concentration of the first salt is about 0.5 M to about 1.5 M; or the concentration of the first salt or the second salt is about 0.5 to about 1.5 M.

97. The process of claim 96, wherein the concentration of the first salt is about 0.5 M.

98. The process of claim 96, wherein the concentration of the second salt is about 0.5 M to about 1.5 M.

99. The process of claim 98, wherein the concentration of the second salt is about 1.35 M.

100. The process of claim 93, wherein the solvent is selected from the group consisting of ethylene carbonate (EC), dimethyl carbonate (DMC), ethyl-methyl carbonate (EMC), propylmethyl carbonate, nitroethyl carbonate, propylene carbonate (PC), diethyl carbonate (DEC), methyl propyl carbonate (MPC), 2,5-dioxahexanedioic acid dimethyl ester, tetrahydrofuran (THF), 7-butyrolactone (GBL), fluoroethylene carbonate (FEC), fluoromethyl ethylene carbonate (FMEC), trifluoroethyl methyl carbonate (F-EMC), fluorinated 3-(1,1,2,2-tetrafluoroethoxy)-1,1,2,2-tetrafluoropropane/1,1,2,2-tetrafluoro-3-(1,1,2,2-tetrafluoroethoxy)propane (F-EPE), fluorinated cyclic carbonate (F-AEC), dioxolane, prop-1-ene-1,3-sultone (PES), sulfolane, acetonitrile (ACN), succinonitrile (SCN), pimelonitrile, suberonitrile, propionitrile, propanedinitrile, glutaronitrile (GLN), adiponitrile (ADN), hexanedinitrile, pentanedinitrile, acetophenone, isophorone, benzonitrile, ethyl propionate, methyl propionate, methylene methanedisulfonate, dimethyl sulfate, dimethyl sulfoxide (DMSO), ethyl acetate, methyl butyrate, dimethyl ether (DME), diethyl ether, dioxolane, gamma butyl-lactone, methyl benzoate, 2-methyl-5-oxooxolane-2-carbonitrile, and combinations thereof.

101. The process of claim 100, wherein the solvent is selected from the group consisting of succinonitrile (SCN), glutaronitile (GLN), sulfolane, ethylene carbonate (EC), ethyl-methyl carbonate (EMC), and combinations thereof.

102. The process of claim 101, wherein the solvent has a water content less than 200 ppm, or less than 150 ppm, or less than 100 ppm, or less than 60 ppm, or less than 50 ppm, or less than 40 ppm, or less than 30 ppm, or less than 20 ppm, or less than 10 ppm.

103. The process of claim 93, wherein the lithium-stuffed garnet thin film or pellet comprises Li_{A}La_{B}Al_{C}M″_{D}Zr_{E}O_{F}, wherein 5<A<8, 1.5<B<4, 0.1<C<2, 0<D<2, 1<E<3, 10<F<13, and M″ is selected from the group consisting of Mo, W, Nb, Y, Ta, Ga, Sb, Ca, Ba, Sr, Ce, Hf, and Rb.

104. The process of claim 93, wherein (3) is performed at a temperature between, or equal to, 0° C. and 60° C.

105. The process of claim 93, wherein (3) is performed at room temperature.

106. The process of claim 95, wherein the at least one surface of the lithium-stuffed garnet thin film or pellet, after (4), has a fluorinated surface.

107. The process of claim 106, wherein the at least one surface of the lithium-stuffed garnet thin film or pellet, after (4), has fluorine or fluoride present at a depth of penetration ranging from about 0.5 m to about 1.5 m.

108. The process of claim 106, wherein the at least one surface of the lithium-stuffed garnet thin film or pellet, after (4), comprises fluorine bonded to one or more elements in the lithium-stuffed garnet.

109. The process of claim 93, wherein the at least one surface is free or substantially free of a contaminant after (3).

110. The process of claim 109, wherein the contaminant is Li₂CO₃ and the at least one surface has Li₂CO₃ on the surface in an amount less than 1 atomic % as measured by XPS.
